(19) United States
(12) Patent Application Publication
(10) Pub. No.: US 2025/0349019 A1
(43) Pub. Date: Nov. 13, 2025

(54) DEPTH MAP GENERATING METHOD AND APPARATUS

(71) Applicants: HYUNDAI MOTOR COMPANY, Seoul (KR); KIA CORPORATION, Seoul (KR)

(72) Inventors: Sunkyung Kim, Hwaseong-si (KR); Sohee Kim, Hwaseong-si (KR)

(73) Assignees: HYUNDAI MOTOR COMPANY, Seoul (KR); KIA CORPORATION, Seoul (KR)

(21) Appl. No.: 18/940,304

(22) Filed: Nov. 7, 2024

(30) Foreign Application Priority Data
May 7, 2024 (KR) 10-2024-0059907

(51) Int. Cl. G06T 7/55; G01S 17/89

(52) U.S. Cl. CPC G06T 7/55; G01S 17/89; G06T 2207/10024; G06T 2207/20084

(57) ABSTRACT

A depth map generating method and a depth map generating apparatus are provided. The depth map generating method includes acquiring an RGB color image through a monocular camera provided in a robot system; acquiring a 3D point cloud through a light detection and ranging (LiDAR) sensor provided in the robot system; generating a sparse depth map including only depth information for some points in a given space from the 3D point cloud; inputting the RGB color image and the sparse depth map into a pre-trained diffusion model; and generating a dense depth map including depth information for all points in the given space.

### CROSS-REFERENCE TO RELATED APPLICATION

This application claims the priority to and the benefit of Korean Patent Application No. 10-2024-0059907 filed in the Korean Intellectual Property Office on May 7, 2024, the entire contents of which are incorporated herein by reference.

### TECHNICAL FIELD

The present disclosure relates to a depth map generating method and a depth map generating apparatus.

### BACKGROUND

Human-Robot Interaction (HRI) is a field of research to understand, design, and evaluate interactions between humans and robots. Key aspects of the HRI include communication and interaction, design and aesthetics, safety and trust, social interaction, adaptability, and learning. Specifically, in physical interactions between humans and robots, it is important for robots to behave in a predictable and reliable manner, recognize an environment and human condition, and adjust a behavior accordingly. Depth estimation is essential in implementing these aspects. A depth map represents depth information of an object or environment in a three-dimensional space in a two-dimensional image format, and each pixel value of the depth map may represent a distance of a corresponding point. Depth maps may be used not only for human-robot interaction, but also for 3D reconstruction, object detection and tracking, scene understanding, and robot navigation for robots to perceive surroundings thereof and move around by avoiding obstacles.

The subject matter described in this background section is intended to promote an understanding of the background of the disclosure and thus may include subject matter that is not already known to those of ordinary skill in the art.

### SUMMARY

The present disclosure provides a depth map generating method and a depth map generating apparatus capable of generating a sparse depth map and a dense depth map from data acquired through a robot sensor.

According to an embodiment, a depth map generating method includes acquiring an RGB color image through a monocular camera provided in a robot system. The method further includes acquiring a 3D point cloud through a light detection and ranging (LiDAR) sensor provided in the robot system. The method further includes generating a sparse depth map including only depth information for some points in a given space from the 3D point cloud. The method further includes inputting the RGB color image and the sparse depth map into a pre-trained diffusion model. The method further includes generating a dense depth map including depth information for all points in the given space.

In an embodiment, the depth map generating method may further include training the pre-trained diffusion model by using the sparse depth map as training data according to a predetermined setting.

In an embodiment, training the pre-trained diffusion model may include reading the predetermined setting. Training the pre-trained diffusion model may further include normalizing a depth value of the sparse depth map used as the training data to a value in a range of −1 to 1, when it is determined that the predetermined setting includes a first setting. Training the pre-trained diffusion model may further include training the pre-trained diffusion model based on the sparse depth map on which the normalization has been performed.

In an embodiment, training the pre-trained diffusion model may include reading the predetermined setting. Training the pre-trained diffusion model may further include determining a condition to be given along with noise, as an input to the pre-trained diffusion model, when it is determined that the predetermined setting includes a second setting. Training the pre-trained diffusion model may further include concatenating the determined condition with the noise. Training the pre-trained diffusion model may further include training the pre-trained diffusion model based on the condition concatenated with the noise.

In an embodiment, the condition may include any one of a first condition, a second condition, a third condition, a fourth condition, or a fifth condition. The first condition may include the sparse depth map. The second condition may include the RGB color image and the sparse depth map. The third condition may include the RGB color image, an edge image, and the sparse depth map. The fourth condition may include a gray image and the sparse depth map. The fifth condition may include the gray image, the edge image, and the sparse depth map.

In an embodiment, training the pre-trained diffusion model may include reading the predetermined setting. Training the pre-trained diffusion model may further include giving the sparse depth map as a condition to each of internal layers constituting the pre-trained diffusion model, when it is determined that the predetermined setting may include the third setting. Training the pre-trained diffusion model may further include training the pre-trained diffusion model to which the condition is given, based on the sparse depth map.

In an embodiment, training the pre-trained diffusion model may include reading the predetermined setting. Training the pre-trained diffusion model may further include training the pre-trained diffusion model by including a pixel having a value of 0 in a ground truth image in the training data, when it is determined that the predetermined setting may include a fourth setting.

In an embodiment, training the pre-trained diffusion model may include reading the predetermined setting. Training the pre-trained diffusion model may further include training the pre-trained diffusion model without including a pixel having a value of 0 in a ground truth image in the training data, when it is determined that the predetermined setting may include a fifth setting.

In an embodiment, training the pre-trained diffusion model may include using the generated dense depth map as a ground truth image.

In an embodiment, the depth map generating method may further include searching for a pixel having a depth value of 0 among pixels constituting the dense depth map. The method may further include calculating a value of the pixel having the depth value of 0 based on pixels located around the searched pixel and having a depth value other than 0 to fill the dense depth map with the calculated value.

In an embodiment, filling the dense depth map may include calculating the value of the pixel having the depth value of 0 through a Gaussian random function and filling the dense depth map with the calculated value.

In an embodiment, filling the dense depth map may include calculating the value of the pixel having the depth value of 0 as an average of values included in a 3×3 filter surrounding the pixel having the depth value of 0 and filling the dense depth map with the calculated value.

According to another embodiment, a depth map generating apparatus includes at least one memory device configured to store program code. The apparatus further includes at least one processor configured, by executing the program code stored in the at least one memory device, to acquire an RGB color image through a monocular camera provided in a robot system. The at least one processor is further configured to acquire a 3D point cloud through a light detection and ranging (LiDAR) sensor provided in the robot system. The at least one processor is further configured to generate a sparse depth map including only depth information for some points in a given space from the 3D point cloud. The at least one processor is further configured to input the RGB color image and the sparse depth map into a pre-trained diffusion model. The at least one processor is further configured to generate a dense depth map including depth information for all points in the given space.

In an embodiment, the at least one processor may further train the pre-trained diffusion model by using the sparse depth map as training data according to a predetermined setting.

In an embodiment, the at least one processor may further read the predetermined setting. The at least one processor may further give the sparse depth map as a condition to each of internal layers constituting the pre-trained diffusion model, when it is determined that the predetermined setting may include a third setting. The at least one processor may further train the pre-trained diffusion model to which the condition is given, based on the sparse depth map.

In an embodiment, the at least one processor may further read the predetermined setting. The at least one processor may further train the pre-trained diffusion model by including a pixel having a value of 0 in a ground truth image in the training data, when it is determined that the predetermined setting may include a fourth setting.

In an embodiment, the at least one processor may further read the predetermined setting. The at least one processor may further train the pre-trained diffusion model without including a pixel having a value of 0 in a ground truth image in the training data, when it is determined that the predetermined setting may include a fifth setting.

In an embodiment, the at least one processor may further search for a pixel having a depth value of 0 among pixels constituting the dense depth map, The at least one processor may further calculate a value of the pixel having the depth value of 0 based on pixels located around the searched pixel and having a depth value other than 0 to fill the dense depth map with the calculated value.

In an embodiment, the at least one processor may further calculate the value of the pixel having the depth value of 0 through a Gaussian random function. The at least one processor may further fill the dense depth map with the calculated value.

In an embodiment, the at least one processor may further calculate the value of the pixel having the depth value of 0 as an average of values included in a 3×3 filter surrounding the pixel having the depth value of 0 and filling the dense depth map with the calculated value.

### BRIEF DESCRIPTION OF THE DRAWINGS

FIG. 1 is a block diagram illustrating a depth map generating apparatus according to an embodiment.

FIG. 2 is a flowchart illustrating a depth map generating method according to an embodiment.

FIG. 3 is a flowchart illustrating a depth map generating method according to an embodiment.

FIG. 4 is a diagram illustrating an operation example of a depth map generating apparatus according to an embodiment.

FIGS. 5A, 5B, and 5C are diagrams illustrating an operation example of a depth map generating apparatus according to an embodiment.

FIG. 6 is a diagram illustrating an operation example of a depth map generating apparatus according to an embodiment.

FIGS. 7A, 7B, 8A, and 8B are diagrams illustrating an operation example of a depth map generating apparatus according to an embodiment.

FIGS. 9A, 9B, 10A, and 10B are diagrams illustrating an operation example of a depth map generating apparatus according to an embodiment.

FIG. 11 is a diagram illustrating a computing device according to an embodiment.

### DETAILED DESCRIPTION

Hereinafter, embodiments are described in detail with reference to the accompanying drawings such that the embodiments may be easily practiced by those having ordinary skill in the art to which the disclosure pertains. However, the present disclosure may be modified in various different ways and is not limited to the embodiments set forth herein. Portions that are irrelevant to the present disclosure have been omitted, and same reference numerals designate same or like elements throughout the present disclosure.

Throughout the present disclosure, unless explicitly described to the contrary, the term “comprise” and variations, such as “comprises” or “comprising”, should be understood to include stated elements without excluding any other elements. It should be understood that, although the terms first, second, etc. may be used herein to describe various elements, these elements should not be limited by these terms. These terms are only used to distinguish one element from another.

The terms “part” “unit”, “module” described in the present disclosure refer to a unit capable of processing at least one function or operation described in the present disclosure and may be implemented by hardware or circuit, software, or a combination of a hardware or circuit and software. In addition, at least some components or functions of a depth map generating method and a depth map generating apparatus according to the embodiments described below may be implemented as a program or software, and the program or software may be stored in a computer-readable medium.

When a controller, module, component, device, element, part, unit, or the like of the present disclosure is described as having a purpose or performing an operation, function, or the like, the controller, module, component, device, element, part, unit, or the like should be considered herein as being “configured to” meet that purpose or to perform that operation or function. Each controller, module, component, device, element, part, unit, and the like may separately embody or be included with a processor and a memory, such as a non-transitory computer readable media, as part of the apparatus.

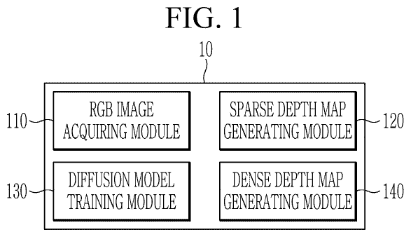

FIG. 1 is a block diagram illustrating a depth map generating apparatus according to an embodiment.

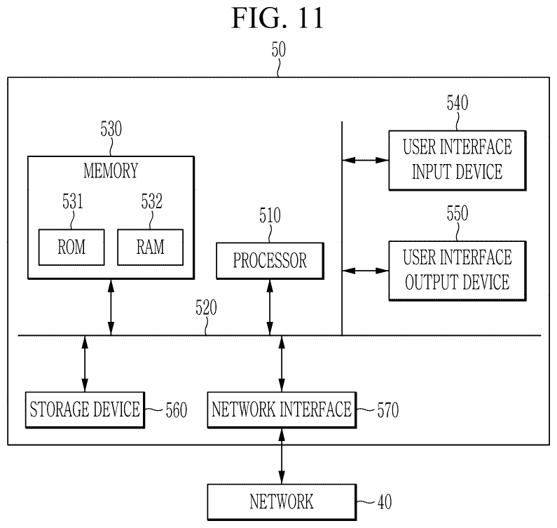

Referring to FIG. 1, a depth map generating apparatus 10 according to an embodiment may execute program code loaded in one or more memory devices through one or more processors. For example, the depth map generating apparatus 10 may be implemented as a computing device 50, as described below with reference to FIG. 11. In this case, one or more processors may correspond to a processor 510 of the computing device 50, and one or more memory devices may correspond to a memory 520 of the computing device 50. The program code may be executed by one or more processors to perform functions for generating a sparse depth map and a dense depth map from data acquired through sensors of a robot. In the present disclosure, the term “module” is used to logically distinguish between these functions performed by the program code.

The depth map generating apparatus 10 according to an embodiment may execute the program code including an RGB image acquiring module 110, a sparse depth map generating module 120, a diffusion model training module 130, and a dense depth map generating module 140.

The RGB image acquiring module 110 may acquire an RGB color image through a monocular camera provided in a robot system. The monocular camera may capture an image through one lens. The monocular camera is cost-effective, simple to construct, and compact, so the monocular camera may be widely used by robots to perceive surroundings thereof and identify or track an object. However, the monocular camera generally does not provide depth information directly. The sparse depth map generating module 120 may acquire a 3D point cloud

through a light detection and ranging (LiDAR) sensor provided in the robot system and may generate a sparse depth map including only depth information on some points in a given space from the 3D point cloud.

The LiDAR sensor may measure a distance to a surrounding environment using light. Specifically, the LiDAR sensor may fire a laser pulse to a target and measure time for which a reflected pulse is returned to calculate a distance to the target. The LiDAR sensor may generate a three-dimensional (3D) map of the surrounding environment based on the information. The LiDAR sensor may measure distances with high precision and generate detailed 3D images, allowing for a precise understanding of the environment, and may also be used in dark environments or bad weather.

The 3D point cloud acquired through the LiDAR sensor is a set of points in space, and each point may correspond to a specific location in an actual physical environment. In an embodiment, 3D point cloud data may include information, such as point location (e.g., x, y, z coordinates), reflection intensity, and color (e.g., an RGB value).

The sparse depth map may not include all points but only points selected

according to certain predetermined criteria. Several points selected from the 3D point cloud may be projected onto a 2D plane to generate a 2D image, and each pixel of the 2D image may be assigned a depth value (e.g., a Z coordinate) of the corresponding 3D point. A region not projected onto the 2D plane remains without a depth value.

The diffusion model training module 130 may train a diffusion model using the sparse depth map generated by the sparse depth map generating module 120 as training data according to predetermined setting.

The diffusion model is an algorithm designed by comparing a process of generating data to a diffusion process in physics. The diffusion model may first include a diffusion process of gradually damaging actual data with noise and then may include an inverse process or inverse diffusion process of restoring the original data from noise. The diffusion process is performed through several detailed operations, and, in each detailed operation, noise is added to the data. Ultimately, the data may become completely noisy. In the reverse process, the diffusion model learns how to restore noise to the original data, noise may be finally removed, and the original features of the data may be recovered.

For example, between the original image xo and an image x_{T} that follows a completely random Gaussian, the diffusion process q(xₜ|xₜ₋₁) proceeding from an intermediate image xₜ₋₁ and an intermediate image xₜ may be a process of sequentially applying Gaussian Markov chain, starting from the original image x0 to the image x_{T} through the intermediate image xₜ₋₁ and an intermediate image xₜ. Also, the purpose of the diffusion model may be learning a reverse process p(xₜ₋₁|xₜ), starting from image x_{T} and returning to the original image x₀. In the diffusion model, it is aimed at narrowing a distance between p(xₜ₋₁|xₜ) proceeding from the intermediate image xₜ to the intermediate image xₜ₋₁ and q(xₜ|xₜ₋₁) proceeding from the intermediate image xₜ₋₁ to the intermediate image xₜ. After training of the diffusion model is complete, a realistic image x₀ may be generated, starting from the image x_{T} that follows the completely random Gaussian through sequential sampling. In an embodiment, the distance between p(xₜ₋₁|xₜ) and q(xₜ|xₜ₋₁) may be measured in distance using Kullback-Leibler divergence (KL-Divergence). Minimizing the distance between p(xₜ₋₁|xₜ) and q(xₜ|xₜ₋₁) may be minimizing the Kullback-Liebler divergence.

The dense depth map generating module 140 may input the RGB color image acquired from the RGB image acquiring module 110 and the sparse depth map generated by the sparse depth map generating module 120 into the pre-trained diffusion model to generate a dense depth map including depth information for all points in the given space.

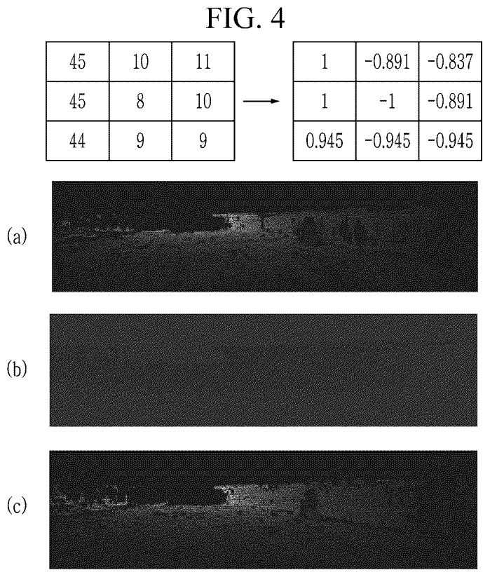

In an embodiment, the depth map generating apparatus may train the diffusion model along different performance paths according to a predetermined setting. Specifically, the diffusion model training module 130 may read the predetermined setting. When it is determined that the predetermined setting includes a first setting, the diffusion model training module may normalize the depth value of the sparse depth map used as training data to a value in the range of −1 to 1 and may train the diffusion model based on the sparse depth map on which the normalization has been performed. An example of the operation is described below with reference to FIG. 4. If the predetermined setting does not include the first setting, the diffusion model training module 130 may not perform this process.

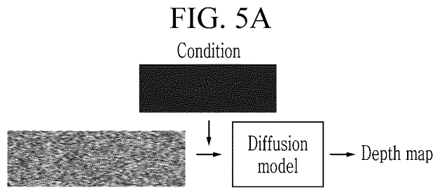

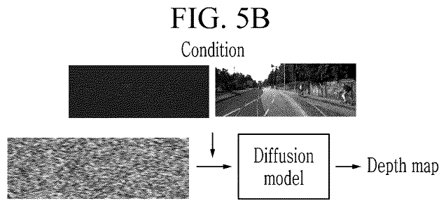

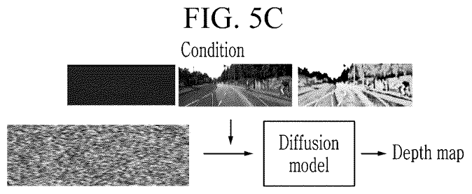

Meanwhile, the diffusion model training module 130 may read the predetermined setting. When it is determined that the predetermined setting includes a second setting, the diffusion model training module 130 may determine a condition given with noise as an input to the diffusion model, may concatenate the determined condition with noise, and may train the diffusion model based on the condition concatenated with noise. Here, the condition may include any one of a first condition, a second condition, a third condition, a fourth condition, or a fifth condition. The first condition may include the sparse depth map, the second condition may include the RGB color image and the sparse depth map, the third condition may include the RGB color image, an edge image, and the sparse depth map, the fourth condition may include a gray image and the sparse depth map, and the fifth condition may include the gray image, the edge image, and the sparse depth map. An operation example thereof is described below with reference to FIGS. 5A, 5B, and 5C. If the predetermined setting does not include the second setting, the diffusion model training module 130 may not perform this process.

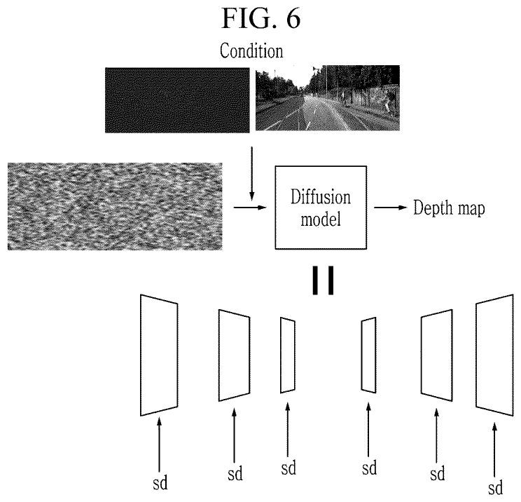

Meanwhile, the diffusion model training module 130 may read the predetermined setting. When it is determined that the predetermined setting includes the third setting, the diffusion model training module 130 gives the sparse depth map as a condition to each of internal layers constituting the diffusion model and trains the diffusion model given with the condition based on the sparse depth map. An operation example thereof is described below with reference to FIG. 6. If the predetermined setting does not include the third setting, the diffusion model training module 130 may not perform this process.

The diffusion model training module 130 may read the predetermined setting. When it is determined that the predetermined setting includes the fourth setting, the diffusion model training module 130 may train the diffusion model by including a pixel having a value of 0 in a ground truth image in the training data. Alternatively, if it is determined that the predetermined setting includes the fifth setting, the diffusion model training module 13 may train the diffusion model without including the pixel having the value of 0 in the ground truth image in the training data.

In this manner, the depth map generating apparatus may determine different performance paths according to a predetermined setting (for example, at least one of the first setting, the second setting, the third setting, the fourth setting, or the fifth setting) by reflecting and considering a specific implementation purpose and environment. The depth map generating apparatus may train the diffusion model according to the determined performance path. Thus, prediction quality and accuracy suitable for the situation may be improved. For example, by applying different settings to a case applied to human-robot interaction, a case applied to general object detection and tracking, a case applied to scene understanding, and a case applied to robot navigation, an appropriate depth map creation may be implemented by considering the performance required in the situation and consumed computing resources.

In an embodiment, the depth map generating apparatus may use a dense depth map generated during training of the diffusion model as a ground truth image. For example, the dense depth map generated when training a diffusion model may be used as a pseudo ground truth for a discrete depth map and may be used as a final ground truth for a continuous depth map. Through this, even when the ground truths are not sufficient, the amount of ground truth data may be increased based on the ground truths acquired through the diffusion model.

In an embodiment, the depth map generating apparatus may search for a pixel having a depth value of 0 among pixels constituting the dense depth map. The depth map generating apparatus may calculate a value of the pixel having the depth value of 0 based on pixels located around the searched pixel and having a non-zero depth value. The depth map generating apparatus may fill the dense depth map with the calculated value. Accordingly, a continuous depth map may be generated.

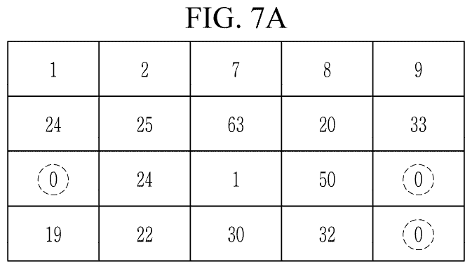

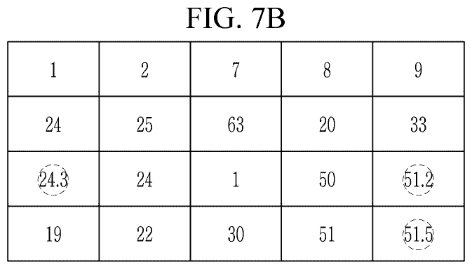

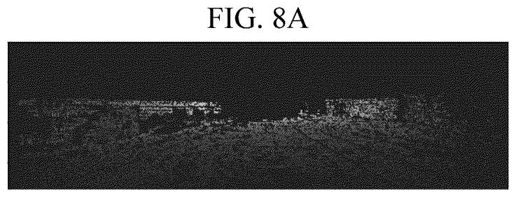

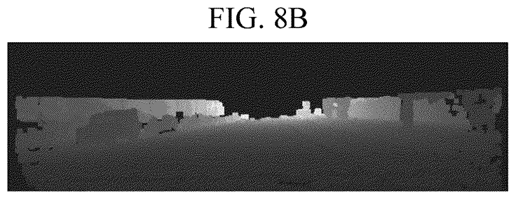

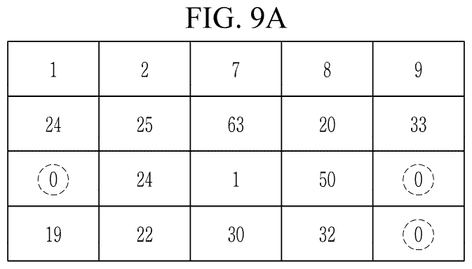

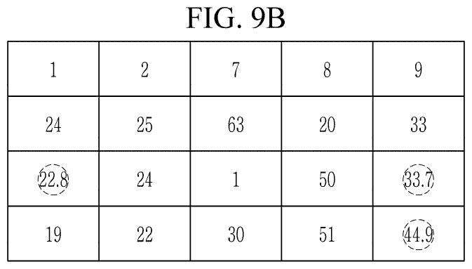

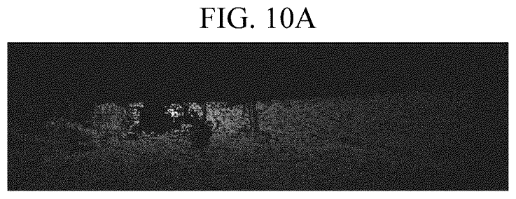

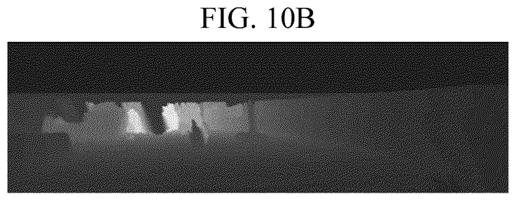

In an embodiment, the depth map generating apparatus may calculate the value of the pixel having the depth value of 0 through the Gaussian random function and may fill the dense depth map. An operation example thereof is described below with reference to FIGS. 7A, 7B, 8A, and 8B. In some other embodiments, the depth map generating apparatus may calculate the value of the pixel having the depth value of 0 as an average of the values included in an n×n filter (e.g., a 3×3 filter) surrounding the pixel having the depth value of 0. The depth map generating apparatus may fill the dense depth map. An operation example thereof is described below with reference to FIGS. 9A, 9B, 10A, and 10B. These two methods may be selected and used by reflecting and considering the specific implementation purpose and environment. For example, different methods may be applied to each of the case applied to human-robot interaction, the case applied to general object detection and tracking, the case applied to scene understanding, and the case applied to robot navigation.

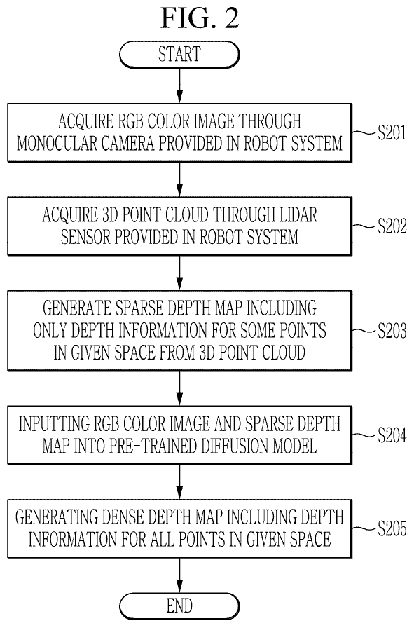

FIG. 2 is a flowchart illustrating a depth map generating method according to an embodiment.

Referring to FIG. 2, the depth map generating method according to an embodiment may include acquiring an RGB color image through a monocular camera provided in a robot system S201. The depth map generating method may include acquiring a 3D point cloud through a LIDAR sensor provided in the robot system S202. The depth map generating method may include generating a sparse depth map including only depth information for some points in a given space from a 3D point cloud S203. The depth map generating method may include inputting the RGB color image and the sparse depth map to a pre-trained diffusion model S204.

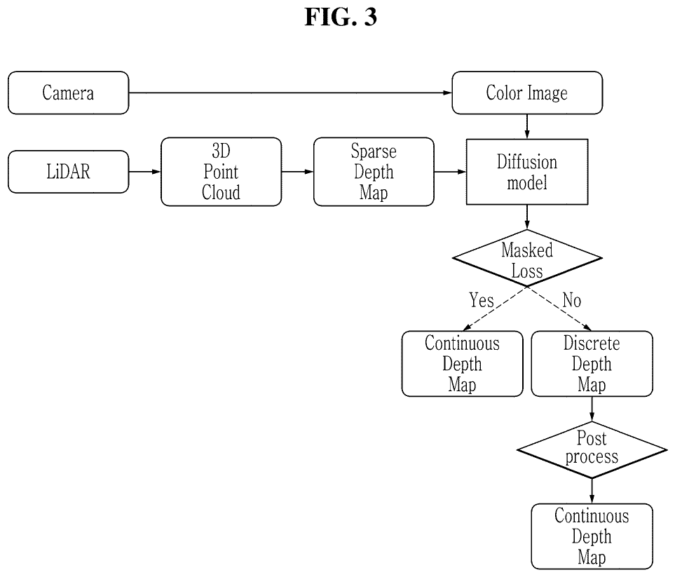

The depth map generating method may include generating a dense depth map including depth information for all points in a given space S205. For more detailed information on the method, the description of the embodiments given in the present disclosure may be referred to or applied, so redundant description is omitted here. FIG. 3 is a flowchart illustrating a depth map generating method according to an embodiment.

Referring to FIG. 3, the depth map generating method according to an embodiment may provide a color image acquired from a camera as a first input to the diffusion model and may provide a sparse depth map generated from a 3D point cloud acquired through a LiDAR sensor as a second input to the diffusion model.

As described above, the diffusion model may perform a diffusion process of gradually damaging actual data with noise and a reverse process or reverse diffusion process of restoring the original data from noise. The training of the diffusion model may focus on accurately modeling the amount of noise that a neural network has to predict at a specific time stage and may minimize loss to induce the neural network to make increasingly accurate predictions. The training of the diffusion model may ultimately allow the neural network to imitate the actual data distribution.

In the present embodiment, as a loss function of the diffusion model, masked loss that applies loss only to data points of interest without calculating loss for data points that the model has to ignore may selectively be used.

Specifically, a mask is generated to determine whether to include the first input and the second input in the loss calculation, and loss corresponding to a data point having a mask of 0 does not contribute to the loss calculation. Thus, when learning is performed only in a partial region, a discrete depth map may be acquired first, and a continuous depth map may be acquired by performing appropriate post-processing thereon. Alternatively, if the mask loss is not used, the continuous depth map may be immediately acquired.

By using mask loss in this manner, learning may be performed more effectively by focusing on data points of interest without being affected by unnecessary or noisy data.

FIG. 4 is a diagram illustrating an operation example of a depth map generating apparatus according to an embodiment.

Referring to FIG. 4, the depth map generating apparatus according to an embodiment normalizes the depth value of the sparse depth map used as training data to a value in the range of −1 to 1 and trains the diffusion model based on the normalized sparse depth map.

For example, the distribution of actual depth values may appear as a value between 0 and 80. In the case of the diffusion model, training is performed by adding noise corresponding to a value between −1 and 1, so when the depth value between 0 and 80 is input as it is to the diffusion model, training may not be performed normally due to a difference in the range of values.

To solve this problem, the depth map generating apparatus may normalize the depth value of the sparse depth map used as training data to a value in the range of −1 to 1 and then may input the normalized value to the diffusion model to perform training. In FIG. 4, (a) shows the ground truth, (b) shows the results of training using non-normalized depth values, and (c) shows the results of training using normalized depth values. It can be seen that case (c) provides superior prediction results compared to (b).

FIGS. 5A, 5B, and 5C are diagrams illustrating an operation example of a depth map generating apparatus according to an embodiment.

Referring to FIGS. 5A, 5B, and 5C, the depth map generating apparatus according to an embodiment may determine a condition given with noise as an input to the diffusion model, may concatenate the determined condition with noise, and may train the diffusion model based on the condition concatenated with noise.

Here, the condition may include any one of a first condition, a second condition, a third condition, a fourth condition, or a fifth condition. The first condition may include the sparse depth map, the second condition may include the RGB color image and the sparse depth map, the third condition may include the RGB color image, an edge image, and the sparse depth map, the fourth condition may include a gray image and the sparse depth map, and the fifth condition may include the gray image, the edge image, and the sparse depth map.

FIG. 5A shows training the diffusion model based on an input concatenating noise with a first condition conditioning only on the sparse depth map. FIG. 5B shows training the diffusion model based on an input concatenating noise with a second condition conditioning only the RGB color image and the sparse depth map. FIG. 5C shows training the diffusion model based on an input concatenating noise with a third condition conditioning the RGB color image, an edge image, and the sparse depth map. The depth map generating apparatus may attempt each condition, may determine a condition that provides a result with a high degree of similarity to the ground truth, and may perform training using the determined condition. In this manner, by determining the optimal conditions for a specific implementation purpose and environment through attempt and evaluation of multiple conditions and performing training based thereon, prediction quality and accuracy may be improved.

FIG. 6 is a diagram illustrating an operation example of a depth map generating apparatus according to an embodiment.

Referring to FIG. 6, the depth map generating apparatus according to an embodiment may give the sparse depth map as a condition to each of the internal layers constituting the diffusion model and may train the diffusion model given the condition based on the sparse depth map.

For example, as shown, the diffusion model may be trained based on the input concatenating noise with the second condition conditioning the RGB color image and the sparse depth map, but in addition, the sparse depth map sd may be individually input to each of the internal layers constituting the diffusion model. Accordingly, training may be performed by referring to the sparse depth information for each layer. Depending on the specific implementation purpose and environment, it may be applied when prediction quality and accuracy are improved when sparse depth information is considered in each layer.

FIGS. 7A, 7B, 8A, and 8B are diagrams illustrating an operation example of a depth map generating apparatus according to an embodiment.

Referring to FIGS. 7A, 7B, 8A, and 8B, the depth map generating apparatus according to an embodiment may calculate a value of a pixel having a depth value of 0 through the Gaussian random function and may fill the dense depth map with the calculated value.

For example, FIG. 7A shows a ground truth depth map including a pixel having a depth value of 0. FIG. 7B shows a ground truth depth map after the pixel having the depth value of 0 is calculated with different values (24.3, 51.2, 51.5). The depth map generating apparatus may store non-zero values among the pixel values of the ground truth depth map in a data structure, such as a list. If there is 0 in neighboring pixels based on the non-zero values stored in the data structure, while looping with respect to the data structure, the depth map generating apparatus may assign the calculated value as a pixel value using the Gaussian random function.

FIG. 8A shows an example of a ground truth depth map before calculating and filling pixel values. FIG. 8B shows an example of the ground truth depth map after calculating and filling pixel values. The ground truth depth map may be used to train the diffusion model or may be used for other purposes. FIGS. 9A, 9B, 10A, and 10B are diagrams illustrating an operation example of a depth map generating apparatus according to an embodiment.

Referring to FIGS. 9A, 9B, 10A, and 10B, the depth map generating apparatus according to an embodiment may calculate a value of a pixel having a depth value of 0 as an average of values included in the n×n filter (e.g., 3×3 filter) surrounding the pixel having the depth value of 0 and may fill the dense depth map.

For example, FIG. 9A shows a ground truth depth map including the pixel having the depth value of 0. FIG. 9B shows a ground truth depth map after the pixel having the depth value of 0 is calculated as different values (22.8, 33.7, 44.9). The depth map generating apparatus may store non-zero values among the pixel values of the ground truth depth map in a data structure, such as a list. If there is 0 in a filter region determined based on a non-zero value stored in the corresponding structure, while looping with respect to the data structure, the depth map generating apparatus may assign a value derived through an average operation as a pixel value. FIG. 10A shows an example of a ground truth depth map before calculating and filling pixel values. FIG. 10B shows an example of a ground truth depth map after calculating and filling pixel values. The ground truth depth map may be used to train the diffusion model or may be used for other purposes.

FIG. 11 is a diagram illustrating a computing device according to an embodiment.

Referring to FIG. 11, the depth map generating method and the depth map generating apparatus according to embodiments may be implemented using a computing device 50.

The computing device 50 may include at least one of a processor 510, a memory 530, a user interface input device 540, a user interface output device 550, or a storage device 560 that communicate over a bus 520. The computing device 50 may also include a network interface 570 that is electrically connected to a network 40. The network interface 570 may transmit or receive signals to and from other entities through the network 40.

The processor 510 may be implemented as various types, such as a micro controller unit (MCU), an application processor (AP), a central processing unit (CPU), a graphics processing unit (GPU), a neural processing unit (NPU), a quantum processing unit (QPU), and may be any semiconductor device that executes instructions stored in the memory 530 or the storage device 560. The processor 510 may be configured to implement the functions and methods described above with reference to FIGS. 1-10.

The memory 530 and the storage device 560 may include various types of volatile or non-volatile storage mediums. For example, the memory may include read-only memory (ROM) 531 and random access memory (RAM) 532. In an embodiment, the memory 530 may be located inside or outside the processor 510, and the memory 530 may be connected to the processor 510 through various known units.

In an embodiment, at least some components or functions of the depth map generating method and the depth map generating apparatus according to the embodiments may be implemented as a program or software running on the computing device 50, and the program or software may be stored in a computer-readable medium. Specifically, the computer-readable medium according to an embodiment may be a program for executing the operations included in the depth map generating method and the depth map generating apparatus according to embodiments in a computer including the processor 510 that executes a program or instructions stored in the memory 530 or the storage device 560.

In an embodiment, at least some components or functions of the depth map generating method and the depth map generating apparatus according to the embodiments may be implemented using hardware or a circuit of the computing device 50 or may be implemented using separate hardware or circuit device that may be electrically connected to the computing device 50.

According to embodiments, a sparse depth map may be generated using data acquired from the LiDAR sensor and the monocular camera provided in the robot system and a sophisticated dense depth map may be generated using the diffusion model. Accordingly, a sufficient amount of depth information may be acquired from the sparse depth map that lacks the amount of information to be used for human interaction or driving. In addition, by using the diffusion model, a discrete depth map corresponding to a pseudo ground truth and a continuous depth map corresponding to the final ground truth may be acquired together.

While the disclosure has been described in connection with embodiments, it should be understood that the present disclosure is not limited to the disclosed embodiments. On the contrary, the present disclosure is intended to cover various modifications and equivalent arrangements included within the spirit and scope of the appended claims.

What is claimed is:

1. A depth map generating method, comprising:
acquiring an RGB color image through a monocular camera provided in a robot system;
acquiring a 3D point cloud through a light detection and ranging (LiDAR) sensor provided in the robot system;
generating a sparse depth map including only depth information for some points in a given space from the 3D point cloud;
inputting the RGB color image and the sparse depth map into a pre-trained diffusion model; and
generating a dense depth map including depth information for all points in the given space.

2. The depth map generating method of claim 1, further comprising:
training the pre-trained diffusion model by using the sparse depth map as training data according to a predetermined setting.

3. The depth map generating method of claim 2, wherein training the pre-trained diffusion model includes:
reading the predetermined setting;
normalizing a depth value of the sparse depth map used as the training data to a value in a range of −1 to 1, when it is determined that the predetermined setting includes a first setting; and
training the pre-trained diffusion model based on the sparse depth map on which the normalization has been performed.

4. The depth map generating method of claim 2, wherein training the pre-trained diffusion model includes:
reading the predetermined setting;
determining a condition to be given along with noise, as an input to the pre-trained diffusion model, when it is determined that the predetermined setting includes a second setting;
concatenating the determined condition with the noise; and
training the pre-trained diffusion model based on the condition concatenated with the noise.

5. The depth map generating method of claim 4, wherein:
the condition includes any one of a first condition, a second condition, a third condition, a fourth condition, or a fifth condition,
the first condition includes the sparse depth map,
the second condition includes the RGB color image and the sparse depth map,
the third condition includes the RGB color image, an edge image, and the sparse depth map,
the fourth condition includes a gray image and the sparse depth map, and
the fifth condition includes the gray image, the edge image, and the sparse depth map.

6. The depth map generating method of claim 2, wherein training the pre-trained diffusion model includes:
reading the predetermined setting;
giving the sparse depth map as a condition to each of internal layers constituting the pre-trained diffusion model, when it is determined that the predetermined setting includes a third setting; and
training the pre-trained diffusion model to which the condition is given, based on the sparse depth map.

7. The depth map generating method of claim 2, wherein training the pre-trained diffusion model includes:
reading the predetermined setting; and
training the pre-trained diffusion model by including a pixel having a value of 0 in a ground truth image in the training data, when it is determined that the predetermined setting includes a fourth setting.

8. The depth map generating method of claim 2, wherein training the pre-trained diffusion model includes:
reading the predetermined setting; and
training the pre-trained diffusion model without including a pixel having a value of 0 in a ground truth image in the training data, when it is determined that the predetermined setting includes a fifth setting.

9. The depth map generating method of claim 2, wherein training the pre-trained diffusion model includes:
using the generated dense depth map as a ground truth image.

10. The depth map generating method of claim 1, further comprising:
searching for a pixel having a depth value of 0 among pixels constituting the dense depth map; and
calculating a value of the pixel having the depth value of 0 based on pixels located around the searched pixel and having a depth value other than 0 to fill the dense depth map with the calculated value.

11. The depth map generating method of claim 10, wherein filling the dense depth map includes:
calculating the value of the pixel having the depth value of 0 through a Gaussian random function; and
filling the dense depth map with the calculated value.

12. The depth map generating method of claim 10, wherein filling the dense depth map includes:
calculating the value of the pixel having the depth value of 0 as an average of values included in a 3×3 filter surrounding the pixel having the depth value of 0 and filling the dense depth map with the calculated value.

13. A depth map generating apparatus, comprising:
at least one memory device configured to store program code; and
at least one processor configured, by executing the program code stored in the at least one memory device, to:
acquire an RGB color image through a monocular camera provided in a robot system;
acquire a 3D point cloud through a light detection and ranging (LiDAR) sensor provided in the robot system;
generate a sparse depth map including only depth information for some points in a given space from the 3D point cloud;
input the RGB color image and the sparse depth map into a pre-trained diffusion model; and
generate a dense depth map including depth information for all points in the given space. cm 14. The depth map generating apparatus of claim 13, wherein the at least one processor is further configured to:
train the pre-trained diffusion model by using the sparse depth map as training data according to a predetermined setting.

15. The depth map generating apparatus of claim 14, wherein the at least one processor is further configured to:
read the predetermined setting;
give the sparse depth map as a condition to each of internal layers constituting the pre-trained diffusion model, when it is determined that the predetermined setting includes a third setting; and
train the pre-trained diffusion model to which the condition is given, based on the sparse depth map.

16. The depth map generating apparatus of claim 14, wherein the at least one processor is further configured to:
read the predetermined setting; and
train the pre-trained diffusion model by including a pixel having a value of 0 in a ground truth image in the training data, when it is determined that the predetermined setting includes a fourth setting.

17. The depth map generating apparatus of claim 14, wherein the at least one processor is further configured to:
read the predetermined setting; and
train the pre-trained diffusion model without including a pixel having a value of 0 in a ground truth image in the training data, when it is determined that the predetermined setting includes a fifth setting.

18. The depth map generating apparatus of claim 13, wherein the at least one processor is further configured to:
search for a pixel having a depth value of 0 among pixels constituting the dense depth map and
calculate a value of the pixel having the depth value of 0 based on pixels located around the searched pixel and having a depth value other than 0 to fill the dense depth map with the calculated value.

19. The depth map generating apparatus of claim 18, wherein the at least one processor is further configured to:
calculate the value of the pixel having the depth value of 0 through a Gaussian random function; and
fill the dense depth map with the calculated value.

20. The depth map generating apparatus of claim 18, wherein the at least one processor is further configured to:
calculate the value of the pixel having the depth value of 0 as an average of values included in a 3×3 filter surrounding the pixel having the depth value of 0 and filling the dense depth map with the calculated value.
